(19) United States
(12) Patent Application Publication
(10) Pub. No.: US 2009/0041043 A1
(43) Pub. Date: Feb. 12, 2009

(54) Communication system, switching node computer and method for determining a control node

(76) Inventors: Thomas Belling, Erding (DE); Mirko Schramm, Berlin (DE)

Correspondence Address: STAAS & HALSEY LLP, SUITE 700, 1201 NEW YORK AVENUE, N.W., WASHINGTON, DC, 20005, US

(21) Appl. No.: 11/991,329

(22) PCT Filed: Aug. 22, 2006
(86) PCT No.: PCT/EP2006/065537

§ 371 Date: Feb. 29, 2008

(30) Foreign Application Priority Data
Aug. 31, 2005 (EP) 05018954.7

(51) Int. Cl. H04L 12/56

(52) U.S. Cl. 370/401

(57) ABSTRACT

A first communications network and a second communications network are part of a communications system that includes at least one communications terminal and an interface computer, coupled to the first communications network, for mapping a data stream between the at least one communications terminal and the first communications network. The first communications network includes at least one control node for controlling the data stream between the interface computer and the at least one communications terminal. The communications system also includes at least one network node, which provides the control node with information relating to the communications terminal that allows the control node to exercise its control function, and at least one switching node which determines the control node associated with the communications terminal concerned so that the information prepared by the at least one network node can be transmitted to the control node.

### CROSS REFERENCE TO RELATED APPLICATIONS

This application is based on and hereby claims priority to European Patent Application No. 05018954.7 filed on Aug. 31, 2005, the contents of which are hereby incorporated by reference.

### BACKGROUND

Described below is a communication system with a first communication network and a second communication network with at least one communication terminal, an interface computer which is coupled to the first communication network for mapping a data stream between the at least one communication terminal and the first communication network and at least one control node in the first communication network for controlling the data stream occurring between the interface computer and the communication terminal.

In the 3GPP (3rd Generation Partnership Project), the so-called “Service-Based Local Policy” (SBLP) is standardized in TS 23.207 and TS 29.207 and TS 29.208 for the service-dependent authorization of the setting up of IP (Internet Protocol) payload connections via the packet-oriented so-called GPRS (General Packet Radio Service) mobile radio network. The GPRS payload connections are also called “Packet Data Protocol” (PDP) contexts. The setting up initiated by a mobile communication terminal, also called user equipment, and the modification of PDP contexts is authorized at an interface computer, the so-called GGSN (Gateway GPRS Support Node), via the go interface by a so-called “Policy Decision Function” (PDF) which knows the services currently used by the communication terminal. The PDF is informed about these services via the so-called Gq interface by an application function which is formed by a network node in the communication system and which exchanges signaling with the communication terminal for negotiating the service. This can be done, for example, by using the “IP Multimedia Subsystem” (IMS) of the Session Initiation Protocol (SIP) used by 3GPP, which is specified in IETF RFC 3261. The authorization specifies, for example, the quality of service (QoS) allowed for the PDP context, i.e. the bandwidth and, by using a QoS class, also the permissible delay of the data packets exchanged during a data transmission.

The so-called “Flow-Based Charging” (FBC) is also standardized in 3GPP in TS 23.125 and TS 29.210 and TS 29.211. In FBC, “Charging Rules” are installed by a “Charging Rules Function” (CRF) via the Gx interface at the GGSN for particular PDP contexts. The charging rules describe IP data streams and rules for accounting for charges, to be applied to them. The CRF selects the charging rules taking into consideration services currently used by the communication terminal about which it is informed by one or more application functions (AF) via the Rx interface.

In the 3GPP, the fusing of the SBLP and FBC functionalities is being investigated for Rel-7 in TR 23.803, where PDF and CRF are combined to form the so-called “Policy Control and Charging Rules Function” (PCRF).

Both in the case of SBLP and in the case of FBC, a control node (PDF or CRF or, in Rel-7, PCRF) of the communication system is thus supplied by one or more application functions with information about the service or services used. The control node uses this information for influencing the behavior of the GGSN with respect to the treatment of the PDP context or contexts for the relevant communication terminal and the data transported therein. The application function sets up the link to the control node responsible for the communication terminal (e.g. a mobile radio terminal). Services which are provided to the same communication terminal by different application functions can use the same PDP contexts for the transport.

For this reason, it is required that precisely one control node is responsible for one communication terminal and it is informed about these services by all the application functions which provide services to this communication terminal.

### SUMMARY

According to the existing standard, it is the object of an application function to communicate with the control node responsible for a communication terminal. In this context, the communication terminal is identified, e.g. by its IP address. In the case of IP Version 6, only the front 64 bits of the IP address are relevant for this purpose. As an alternative, another identifier of the communication terminal such as, for example, the so-called “International Mobile Subscriber Identity” (IMSI) or the so-called “Mobile Station International ISDN Number” (MSISDN) can also be used if the application function knows this identifier.

In the case where there are a number of control nodes in a communication network it is known that in the application functions, a configured table is stored which specifies which control node is responsible for which communication terminal. However, this procedure leads to considerable disadvantages: the configuration of this table means considerable effort for the operator of the communication network, particularly if the configuration must be done in many application functions in the communication network or if the application functions and the control nodes are administered by different network operators. In addition, it is scarcely possible in the short term to change the communication terminals assigned to a control node, for example in order to replace a failed control node or dynamically to distribute the load between a number of control nodes.

According to the existing standard, the so-called “Diameter Protocol” which is specified in IETF RFC 3588 is used for the interface between the application function and the control node (either the Gq or Rx interface). In this arrangement, the application function plays the role of a “Diameter client” and the control node plays the role of a “Diameter server”. The Diameter protocol also defines so-called “relay agents” which forward Diameter messages between Diameter client and Diameter server.

According to the standard, these relay agents, also called Diameter agents, use two methods for determining the next destination when forwarding so-called “requests” or request messages:

If a Diameter request message contains a Diameter node as destination (destination host) which is directly known to the Diameter agent, the Diameter agent directly forwards the message to this destination node. This is called Diameter “request forwarding”. The Diameter agent can obtain knowledge about the destination node either by a so-called “peer discovery” procedure or by configuration.

If, in contrast, the destination node is not known to the Diameter agent, or no destination node is specified, the Diameter agent determines the destination of the message by a so-called “realm”, specified in the request message, and an identifier contained in this message, the so-called “application identifier”. This procedure is called Diameter “request routing”. The realm specifies an area of the IP network used for the transport (for example the network part of an individual network operator) in which the Diameter server, i.e. the control node, is supposed to be located. If the Diameter agent is not located in the specified realm, it forwards the message to a Diameter agent in the specified realm.

The identifier (application identifier) designates the Diameter application which must be provided by the Diameter server, i.e. by the control node. If the Diameter agent is located in the specified realm, it forward the message to a Diameter server which supports the specified Diameter application.

If an application function thus does not specify a Diameter destination node in a Diameter request message, this request message is sent by Diameter “request routing” to any control node of the specified realm which supports the corresponding Diameter application. It is thus not ensured that all messages relating to a particular communication terminal are sent to the same control node.

Therefore, it is desired to specify a communication system and a method for operating a communication system in which the disadvantages described above can be avoided.

The communication system described herein has a first communication network and a second communication network with at least one communication terminal. An interface computer is provided which is coupled to the first communication network for mapping a data stream between the at least one communication terminal and the first communication network.

At least one control node in the first communication network is provided for controlling the data stream occurring between the interface computer and the communication terminal. A network node provides the control node with information relating to the communication terminal for carrying out its control function. Finally, a switching node is provided which determines the control node allocated for a particular communication terminal so that the information provided by the at least one network node can be conveyed to this control node.

The first communication network can be a communication network administered and operated by an operator, which, for example, is a component of the Internet. The information relating to the communication terminal, provided for the control node by the at least one network node, is information about the services used by the communication terminal.

Providing a switching node which determines the control node allocated for a relevant communication terminal enables the control node to obtain all service information from one or also a number of network nodes which provide services to the communication terminal. In this context, no information configured in the control node or in the network node about the communication terminals is required. This makes it possible in a particularly advantageous manner to avoid the provision of configured tables in the network nodes which contain information about which control node is responsible for which communication terminal. This considerably simplifies the administration of the communication network for the operator since these tables do not need to be configured. This advantage becomes noticeable especially when the communication network has a multiplicity of network nodes which must be supplied with configured information without the presence of a switching node. It is also beneficial when the network nodes and the control nodes are administered by different network operators. Furthermore, it is possible in the communication system to alter within a short time the communication terminals assigned to a control node, for example for replacing a failed control node or dynamically distributing the load between a number of control nodes.

In a development of the communication system, the at least one network node, the at least one control node and the at least one switching node are arranged in the first communication network, a communication occurring between the control node and the switching node and a communication occurring between the network node and the switching node in accordance with the Diameter protocol.

In a further embodiment, the network node is represented by an application functionality or application function or by the interface computer.

A further embodiment of the communication system provides that the second communication network is based on the GPRS (General Packet Radio Service) standard and the interface computer is a Gateway GPRS Support Node (GGSN) computer. As an alternative, the second communication network can be based on the WLAN (Wireless Local Area Network) standard, the interface computer being a Packet Data Gateway (PDG) computer.

It is also appropriate if the at least one switching node forms an edge node of the first communication network. In this embodiment the switching node can represent a central input node for all network nodes outside the first communication network. In this arrangement, secure connections (so-called Security Associations) to the network nodes only need to be set up at the switching node but not at the control nodes. A further advantage of this embodiment is that the control nodes are shielded against so-called “denial of service” attacks but still remain available for the network nodes within the first communication network.

In a further embodiment, a request message is examined for an identifier identifying the communication terminal for the determination of the control node responsible for the communication terminal by the switching node. The communication terminal can be identified by its IP address, the International Mobile Subscriber Identity (IMFSI) or the Mobile Station International ISDN number. In the case of identification by the IP address, only the first 64 bits of the IP address are of significance in the case of IP version 6.

In a first embodiment of the communication system, the switching node is arranged for forwarding the request message directly to the control node responsible for the communication terminal. In this arrangement, it can be provided, on the one hand, that the switching node exclusively forwards the first request message to the control node responsible for the communication terminal and then transmits an answer message, generated by the control node, to the network node. Further communication can then take place directly between the control node and the network node. On the other hand, the switching node can be arranged for switching all messages exchanged between the network node and the control node. In other words, this means that the switching node remains in the connection for the duration of the entire data exchange between control node and application function of messages.

In an alternative embodiment, the switching node is arranged for generating, as a response to a request message generated by a network node, an answer message and to convey it to the network node, in which the control node responsible for the communication terminal is specified. In this arrangement, it is appropriate that the network node first addresses the switching node in its first request message regarding a new service. Further communication then takes place directly between the responsible control node and the network node.

In a further appropriate embodiment, it is provided that a relay agent is arranged between the control node and the switching node and/or between the switching node and the network node, which is arranged for forwarding request and/or answer messages between these nodes. Due to the possibility of not having to transmit request and/or answer messages directly between the switching node and control node or a network node, the communication system may be have large complex communication networks.

In a further embodiment, a source and a destination for the message is specified in each request message and in each answer message, the network node specifying the switching node as the destination in a request message.

In one embodiment, the switching node, when receiving the request message, replaces the destination specified by the network node in the request message and specifies the control node as the new destination and/or replaces the destination specified by the control node in the answer message and specifies the network node as the new destination.

According to a further embodiment, the switching node, when receiving the request message, can leave unchanged the source specified by the network node in the request message or, when receiving the answer message, leave unchanged the source specified by the control node in the answer message. If the network node and the control node then exchange subsequent messages, they can do this by directly specifying the destination node. According to this embodiment, it is thus not necessary that the switching node forwards subsequent messages between the network node and the control node.

In another embodiment, the switching node, when receiving the request message, replaces the source specified by the network node in the request message or, when receiving the answer message, replaces the source specified by the control node in the answer message. The term of source is in each case to be understood in such a manner that the node specified is that which passes itself off as creator of the message. In this variant, the switching node remains in the connection during the further communication between the control node and the network node.

According to another embodiment, it is provided that the switching node, when receiving the request message of the network node, generates an answer message addressed to the network node in which the control node is named as the destination for the further communication. This can be done by using a “result code” with a predetermined value, e.g. the value “DIAMETER_REDIRECT_INDICATION” if the communication occurs in accordance with the Diameter Protocol as has been described above as an embodiment. In this embodiment, the network node requires configured knowledge of the switching node.

A further embodiment provides that the network node is arranged for generating a request routing message wherein messages exchanged between the switching node and the network node and messages exchanged between the switching node and the control node have different identifiers (application identifiers). This embodiment avoids the network node from needing configured knowledge about the address of the switching node. In one instance, it may be required that the switching node also forwards all other messages which are exchanged between the network node and the control node. In this case, the switching node is arranged for exchanging the identifiers when receiving a message.

In a further embodiment, the network node is arranged for generating a request routing message, wherein messages exchanged between the switching node and the network node and messages exchanged between the network node and the control node have different identifiers (application identifiers). In one instance, the switching node, when receiving the request message of the network node, generates an answer message addressed to the network node in which the control node is named as the destination of the further communication. In this embodiment, too, a result code is generated by the switching node which, however, is different from the value provided in the Diameter Standard, e.g. “DIAMETER_REDIRECT_INDICATION” in order to prevent any relay agents which may be present from forwarding the answer message directly to the specified control node since the latter would refuse such a message with a wrong identifier. In addition, the network node can also be informed in this way that apart from the destination node, the identifier (application identifier) also has to be changed.

If the network node is formed by the interface computer, the latter sends a request message with regard to a PDP context for the print control node, specifying the communication terminal, to the switching node. The type of communication can be implemented as described above.

The exemplary embodiments described in the text which follows relate to different procedures or instances of how the switching node contains information about the allocation of communication terminals to respective control nodes.

According to one embodiment, the switching node has configuration information about the allocation of a communication terminal to a control node. If a number of switching nodes are provided in the first communication network, e.g. for reasons of scaling or redundancy, each of the switching nodes has such configuration information.

In another embodiment, the switching node is arranged for selecting a control node for a communication terminal. According to a further embodiment, this can be done by a control node being selected via the switching node when the identifier identifying the communication terminal, extracted from a request message, is not yet known to the switching node. This variant makes it possible for the switching node to dispense with configured information about an allocation of communication terminals to respective control nodes. In addition, a dynamic load distribution between the control nodes is made possible due to the fact that the switching node assigns the new communication terminal to such a control node which is responsible for the least communication terminals at a given time. In this variant, it is required that the switching computer also determines the responsible control node like the application function, the latter using the same switching node. For this purpose, the interface computer sends the first request message with respect to a PDP context for the control node, specifying the communication terminal to the switching node.

To find out when an identifier of a communication terminal is no longer used and, when it is used again later, when it can be assigned to a new control node, the switching node also forwards all messages of a session between an application function and a control node or between the interface computer and the control node, respectively. For this purpose, the switching node enters itself as origin of each message forwarded. When all sessions between the interface computer and the control node which were allocated to the same identifier have ended, the latter is no longer used and the switching node can delete all stored data with respect to this identifier.

In a further embodiment, a plurality of switching nodes have a communication link with one another in order to be able to perform a data exchange with regard to the dynamically performed allocation of the identifiers identifying communication terminals.

In a further embodiment, the control nodes have knowledge about the allocation of the communication terminals assigned to them and transfer this information in capability exchange messages to the switching node. The capability exchange messages are transmitted when a connection is set up to the switching node. In these messages, the information relating to the terminals supported is inserted. This is an advantage, in particular, if a number of switching nodes are provided in the communication network.

A switching node computer for use in the communication system described above is set up for determining the control node allocated for a relevant communication terminal of a communication system so that the information provided by the at least one network node can be conveyed to this control node.

In a method for processing a message supplied to a switching node from a network node in a communication system as described above, the switching node determines the control node allocated for a relevant communication terminal, whereupon the information provided by the at least one network node is conveyed to this control node.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of a first exemplary embodiment of a communication system;

FIG. 2 is a signal sequence diagram of signaling between an application function, a switching node and a control node according to a first variant;

FIG. 3 is a signal sequence diagram of signaling between an application function, a switching node and a control node according to a second variant;

FIG. 4 is a signal sequence diagram of signaling between an application function, a relay agent, a switching node and a control node according to a first variant;

FIG. 5 is a signal sequence diagram of signaling between an application function, a relay agent, a switching node and a control node according to a second variant;

FIG. 6 is a block diagram of a second exemplary embodiment of a communication system; and

FIG. 7 is a signal sequence diagram of signaling between an interface computer, an application function, a switching node and a control node in a communication system according to FIG. 6.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

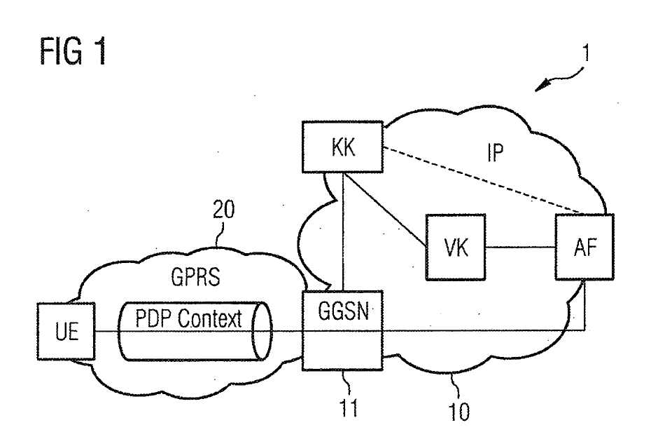

FIG. 1 shows the structure of a communication system 1 in a first exemplary embodiment. The communication system 1 includes a first communication network 10 which, for example, is based on the IP standard and a second communication network 20 based on the GPRS standard, for example.

The first communication network 10 includes an interface computer 11 arranged as Gateway GPRS Support Node GGSN (also called network node GGSN in the text which follows), a control node KK possessing control functions (for example a “policy decision function” PDF, a “charging rules function” CRF or a “policy and charging rules function” PCFR) a switching node VK and an application function AF as further network nodes of the first communication network. The network node GGSN, the control node KK, the switching node VK and AF have a communication connection with one another, communication taking place, for example, by using the Diameter Protocol which will still be referred to in the description following. Instead, communication could also take place by using other protocols.

The second communication network 20 which represents an access network, includes a communication terminal UE which uses one or more PDP contexts as connection to the interface computer 11 (GGSN). The communication terminal UE exchanges signaling and possibly also payload data with the application function AF. The application function AF exchanges messages with the control node KK with the aid of the Diameter Protocol. The application function AF uses the switching node VK for establishing a Diameter connection to the control node KK.

The communication system described herein can also be applied for other types of access networks such as, for example, a second communication network based on the WLAN standard. In the case of WLAN, a so-called “Packet Data Gateway” (PDG) takes the place of the GGSN as interface computer.

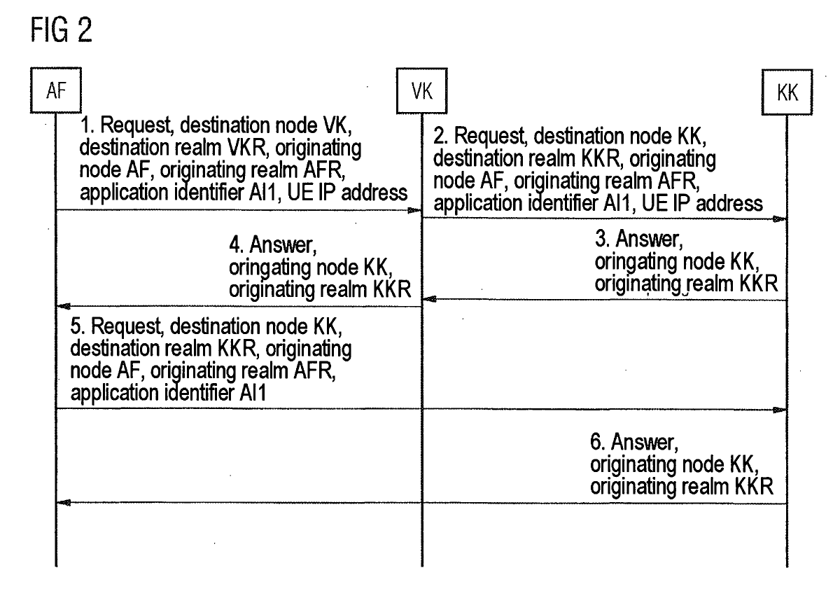

FIG. 2 shows the signaling between an application function AF, a Diameter switching node VK and a control node KK in a first variant. In detail, the signaling operations are as follows:
1. The application function AF begins a new service with a communication terminal UE. Because of this, the application function AF wants to inform the control node KK responsible for the communication terminal UE about the new service but does not know the control node KK. The application function AF has configured information of a responsible switching node VK. The application function AF sends a request message (also called Diameter request message in the text that follows) to the switching node VK in order to set up a new Diameter session to the responsible control node KK. In this message, the application function AF specifies the switching node VK as the destination node and inserts an identifier of the communication terminal UE, for example the IP address of the communication terminal UE. The request message can then be forwarded by Diameter relay agents conforming to standard, which are not shown in the figure.
2. With the aid of the identifier of the communication terminal UE, the switching node VK determines the responsible control node KK, for example by using a configured allocation table. The switching node VK forwards the request message to the control node KK and also specifies in it the control node KK as destination node. The request message can also be forwarded by one or by a number of Diameter relay agents which are not shown in the figure.
3. According to the Diameter standard, the control node KK responds with an answer message and specifies itself in it as originating node.
4. The switching node VK forwards the answer message. The application function AF takes from the answer message the control node KK responsible for the communication terminal UE.
5. The application function AF sends a subsequent request message directly to the control node KK within the same Diameter session. Forwarding of the message by the switching node VK is required only if the application function AF and the control node KK do not have a direct Diameter connection.
6. According to the Diameter standard, the control node KK responds with an answer message directly to the application function AF.

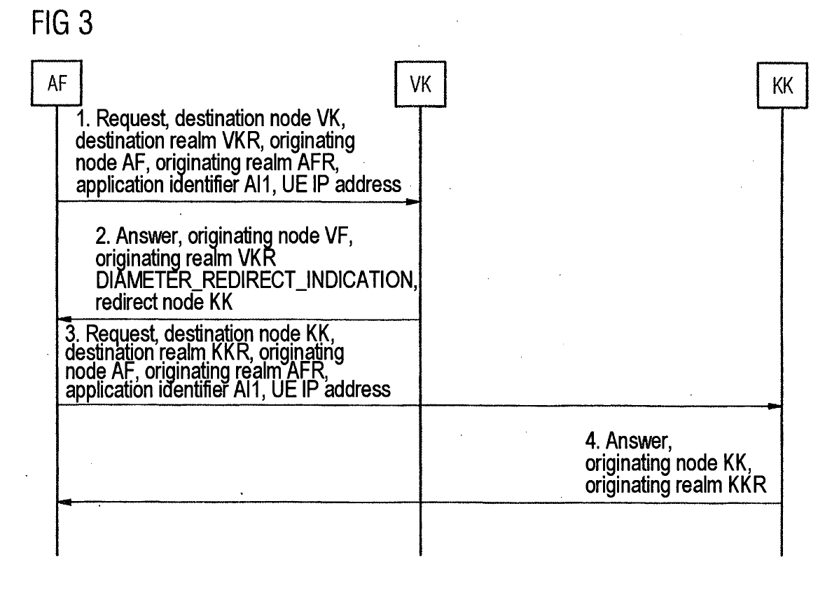

FIG. 3 shows the signaling between an application function AF, a Diameter switching node VK and a control node KK in a second variant. In detail, the signaling operations are as follows:
1. The application function AF begins a new service with a communication terminal UE. For this reason, the application function AF wishes to inform the control node KK responsible for the communication terminal UE about the new service but does not know the control node KK. The application function AF has configured information of a responsible switching node VK. The application function AF sends a request message (Diameter request message) to the switching node VK in order to set up a new Diameter session to the responsible control node KK. In this message, the application function AF specifies the switching node VK as destination node and inserts an identifier of the communication terminal UE, for example the IP address of the communication terminal UE. The request message can be forwarded by the Diameter relay agents conforming to the standard, which are not shown in the figure.
2. The switching node VK determines, with the aid of the identifier of the communication terminal UE, the control node KK responsible for the latter, for example with the aid of a configured allocation table. The switching node VK sends an answer message back to the application function AF wherein a particular value, e.g. the value “DIAMETER_REDIRECT_INDICATION” is specified as so-called result code and the control node KK is designated as so-called “redirect host” or “redirect node”. The answer message to the application function AF can be forwarded by one or by a number of Diameter relay agents which are not shown in the figure. The application function AF takes the responsible control node KK from the answer message.
In an alternative variant, a relay agent can also forward the previously stored request message (compare operation 1, above) to the redirect host KK (not shown here).
3. The application function AF sends a request message directly to the control node KK within the same Diameter session. The application function AF can now also send further subsequent request messages directly to the control node KK within the same Diameter session.
4. According to the Diameter standard, the control node KK answers with an answer message directly to the application function AF.

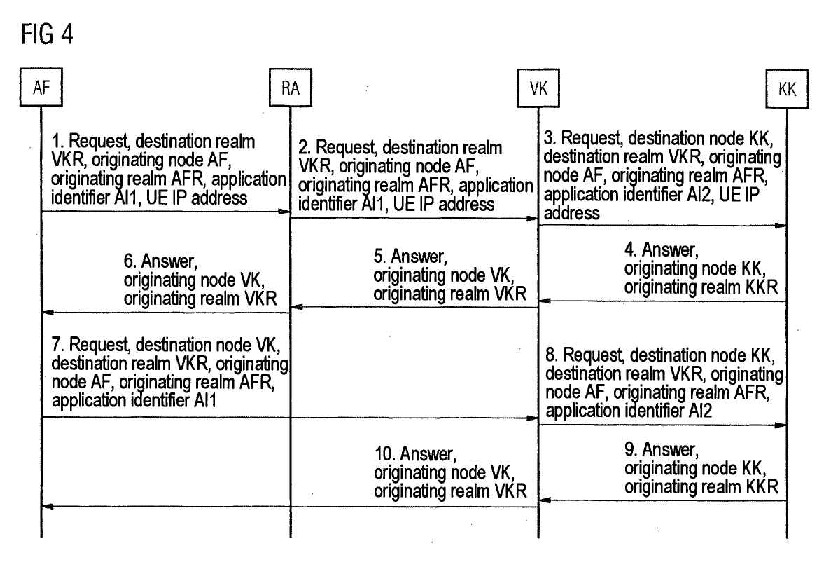

FIG. 4 shows the signaling between an application function AF, a Diameter relay agent RA, a Diameter switching node VK and a control node KK according to a first variant. In detail, the signaling operations are as follows:
1. The application function AF begins a new service with a communication terminal UE. For this reason, the application function AF wants to inform the control node KK responsible for UE about the new service but does not know the control node KK. The application function AF does not have any configured knowledge about a suitable switching node VK either and, instead, wishes to use Diameter routing for finding a switching node.
The application function AF sends a request message (Diameter request message) to the relay agent RA. In this message, the application function AF specifies a realm VKR in which a suitable switching node VK and the control node KK must be located and specifies a special identifier (application identifier or application ID) All which is only assigned to the Diameter switching node VK. Furthermore, the application function AF inserts an identifier of the communication terminal UE into the request message, for example the IP address of the communication terminal UE.
2. With the aid of the specified destination realm VKR and the specified identifier (application identifier) All, the relay agent RA determines a suitable switching node VK. The relay agent RA forwards the request message to the switching node VK.
3. With the aid of the identifier of the communication terminal UE, the switching node VK determines the responsible control node KK, for example with the aid of a configured allocation table. The switching node VK forwards the request message to the control node KK and also specifies therein the control node KK as destination node. The switching node VK specifies itself as origin of the message and uses an altered identifier (application identifier or application ID) AI2 which is assigned to the control node KK. In one embodiment the request message can be forwarded by a further Diameter relay agent (not shown). The switching node VK stores the allocation of the so-called Diameter “user session” between the application function AF and the switching node VK and the new user session between the switching node VK and the control node KK.
4. According to the Diameter standard, the control node KK answers with an answer message and specifies itself as originating node in it.
5. The switching node VK takes from the answer message the responsible control node KK and stores it. The switching node VK forwards the answer message. In this context, the switching node VK uses the stored allocation of the Diameter user session between the application function AF and the switching node VK and the user session between the switching node VK and the control node KK for determining the destination for the answer message. The switching node VK specifies itself as origin of the message.
6. The relay agent RA forwards the answer message. The application function AF takes from the answer message the responsible switching node VK.
7. The application function AF sends a subsequent request message directly to the switching node VK within the same Diameter session. Forwarding the message by the relay agent RA is required only if the application function AF and the switching node VK do not have a direct Diameter connection.
8. The switching node VK determines the destination for the request message based on the stored allocation of the Diameter user session between the application function AF and the switching node VK, of the user session between the switching node VK and the control node KK and of the stored control node KK. The switching node VK forwards the request message to the control node KK and also specifies the control node KK as destination node. The switching node VK specifies itself as origin of the message and uses an altered identifier (application identifier) AI2.
9. According to the Diameter standard, the control node KK answers with an answer message to the switching node VK.
10. The switching node VK forwards the answer message. In this context, the switching node VK uses the stored allocation of the Diameter user session between the application function AF and the switching node VK and of the user session between the switching node VK and the control node KK for determining the destination for the answer message. The switching node VK specifies itself as origin of the message.

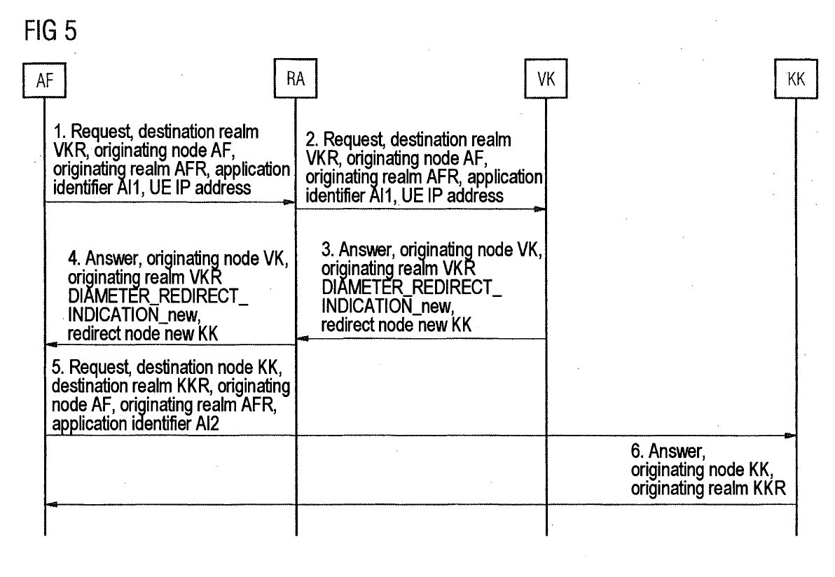

FIG. 5 shows the signaling between an application function AF, a Diameter relay agent RA, a Diameter switching node VK and a control node KK according to a second variant. In detail, the signaling operations are as follows:
1. The application function AF begins a new service with a communication terminal UE. For this reason, the application function AF wishes to inform the control node KK responsible for the communication terminal UE about the new service but does not know the control node KK. The application function AF does not have any configured knowledge about a suitable switching node VK either and, instead, wishes to use the Diameter routing for finding a switching node. The application function AF sends a request message (Diameter request message) to the relay agent RA. In this message, the application function AF specifies the realm VKR in which a suitable switching node VK and the control node KK must be located and specifies a special identifier (application identifier or application ID) AI1 which is only assigned to the Diameter switching node VK. Furthermore, the application function AF inserts an identifier of the communication terminal UE, for example the IP address of the communication terminal UE.
2. With the aid of the specified destination realm VKR and the specified identifier AI1, the relay agent RA determines a suitable switching node VK. The relay agent RA forwards the request message to the switching node VK.
3. The switching node VK determines, with the aid of the identifier of the communication terminal UE, the responsible control node KK, for example with the aid of a configured allocation table. The switching node VK sends an answer message, wherein it specifies as result code a new value, e.g. “DIAMETER_REDIRECT_INDICATION_new” and the control node KK as so-called “redirect host” or “redirect node”.
4. The answer message is forwarded by the relay agent RA. Since the relay agent RA, if it is arranged as Diameter relay agent conforming to the standard, does not know the new value of the result code “DIAMETER_REDIRECT_INDICATION_new”, the relay agent RA is prevented from forwarding the previously stored request message (compare operation 1, above) directly to the redirect node KK. The application function AF takes the responsible control node KK from the answer message.
5. The application function AF sends a request message directly to the control node KK within the same Diameter session. In this message, the application function AF uses a special identifier (application identifier or application ID) AI2 which is only assigned to the control node. The application function AF can now also send further subsequent request messages directly to the control node KK within the same Diameter session.
6. According to the Diameter standard, the control node KK answers with an answer message directly to the application function AF.

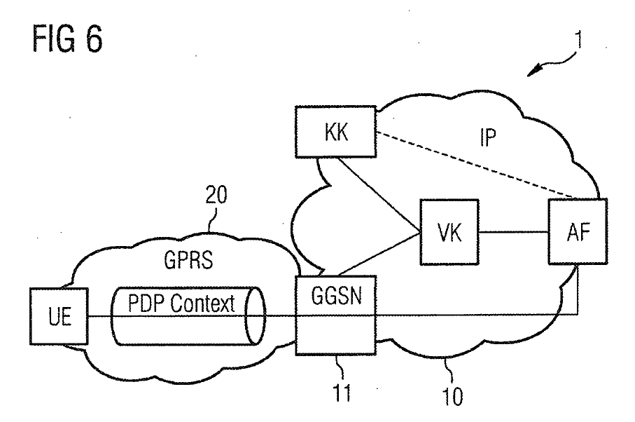

FIG. 6 shows a second exemplary embodiment of a communication system 1. In principle, the structure corresponds to the first exemplary embodiment according to FIG. 1. In contrast to FIG. 1, however, the interface computer 11 (a GGSN in the exemplary embodiment) and the control node KK do not directly exchange messages but the messages are rather forwarded by a switching node VK which determines the control node KK responsible for the communication terminal UE, instead of the interface computer 11 (GGSN).

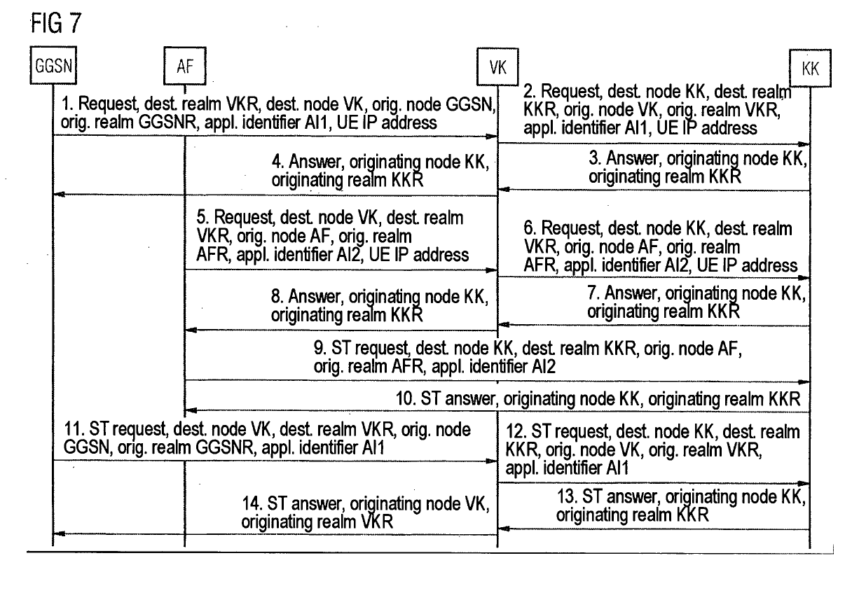

FIG. 7 shows the signaling between the network nodes and the communication terminal UE in a communication system according to FIG. 6. In detail, the signaling operations are as follows:
1. The communication terminal UE has requested the setting-up of a new PDP context at the interface computer 11 or network node GGSN and is assigned an IP address by the network node GGSN. For this reason, the network node GGSN wishes to inform the control node KK responsible for the communication terminal UE about the new service, but does not know the control node KK since the latter is only assigned dynamically to the communication terminal UE. The network node GGSN has configured knowledge about a suitable switching node VK and sends a request message (Diameter request message) to the switching node VK. In this message, the network node GGSN specifies an identifier (application identifier or application ID) AI1 which is assigned to the control nodes for communication with the network node GGSN, and inserts an identifier of the communication terminal UE, for example the IP address of the communication terminal UE.
2. The switching node VK determines, with the aid of the identifier of the UE, that the identifier is not assigned to a control node and selects a control node KK. This can be, for example, the control node KK which, at this time, is assigned the least identifiers and thus the least communication terminals. The switching node VK stores the allocation of the identifier of the communication terminal UE to the control node KK. The switching node VK additionally stores the allocation of the identifier of the communication terminal UE to the Diameter session to the network node GGSN. The switching node VK forwards the request message to the control node KK and also specifies the control node KK as destination node. The switching node VK specifies itself as origin of the message so that all subsequent messages between the network node GGSN and the control node KK are also transmitted via the switching node VK. The switching node VK stores the allocation of the Diameter user session between the network node GGSN and the switching node VK and the new user session between the switching node VK and the control node KK.
3. According to the Diameter standard, the control node KK answers with an answer message and specifies itself as originating node in this message.
4. The switching node VK takes from the answer message the responsible control node KK and stores it. The switching node VK forwards the answer message. In this context, it uses the stored allocation of the Diameter user session between the network node GGSN and the switching node VK and the user session between the switching node VK and the control node KK for determining the destination for the answer message. The switching node VK specifies itself as origin of the message.
5. The application function AF begins a new service with a communication terminal UE. For this reason, the application function AF wishes to inform the control node KK responsible for the communication terminal UE about the new service, but does not know the control node KK. The application function AF has configured information of a responsible switching node VK. The application function AF sends a request message (Diameter request message) to the switching node VK for setting up a new Diameter session to the responsible control node KK. In this message, the application function AF specifies the switching node VK as destination node and inserts an identifier of the communication terminal UE, for example the IP address of the communication terminal UE. In this message, the application function AF specifies an identifier (application identifier or application ID) AI2 which is assigned to the control node KK for communication with the application functions.
6. With the aid of the identifier of the communication terminal UE and of the previously stored allocation, the switching node VK determines the responsible control node KK. The switching node VK forwards the request message to the control node KK and also specifies therein the control node KK as destination node.
7. According to the Diameter standard, the control node KK answers with an answer message and specifies itself as originating node in this message.
8. The switching node VK forwards the answer message. The application function AF takes the responsible control node KK from the answer message.
9. The application function AF ends the service with the communication terminal UE. The application function AF sends a so-called session termination (ST) request message directly to the control node KK within the same Diameter session. Forwarding the message by the switching node VK is required only if the application function AF and the control node KK do not have a direct Diameter connection.
10. According to the Diameter standard, the control node KK answers with an answer message directly to the application function AF.
11. The communication terminal UE breaks down the PDP context and the network node GGSN releases the IP address allocated to the communication terminal UE again. The network node GGSN sends a session termination (ST) request message for informing the control node KK and the switching node VK about the breaking-down of the PDP context and for ending the corresponding Diameter session.
12. The switching node VK deletes the allocation of the Diameter session to the network node GGSN to the identifier of the communication terminal UE and checks whether the identifier is still allocated to the network node GGSN in other Diameter sessions. This could be implemented by the communication terminal UE utilizing a number of PDP contexts. Since the identifier is no longer allocated to any Diameter session, the switching node VK also deletes the allocation of the identifier to the control node KK. The switching node VK determines the destination for the request message based on the stored allocation of the so-called Diameter user session between the application function AF and the switching node VK and the user session between the switching node VK and the control node KK and of the stored control node KK. The switching node VK forwards the request message to the control node KK and also specifies in it the control node KK as destination node. The switching node VK specifies itself as origin of the message.
13. According to the Diameter standard, the KK answers with an answer message to the switching node VK.
14. The switching node VK forwards the answer message. In this context, it uses the stored allocation of the Diameter user session between the application function AF and the switching node VK and of the user session between the switching node VK and the control node KK for determining the destination for the answer message. The switching node VK specifies itself as origin of the message.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-29. (canceled)

30. A communication system, comprising:
a first communication network;
a second communication network including at least one communication terminal;
an interface computer, coupled to said first communication network, mapping a data stream between the at least one communication terminal and said first communication network;
at least one control node in said first communication network, controlling the data stream between said interface computer and the at least one communication terminal;
at least one network node providing said at least one control node with information relating to the at least one communication terminal that is used in performing the controlling of the data stream; and
at least one switching node determining an appropriate control node allocated for a relevant communication terminal so that the information provided by said at least one network node can be conveyed to the appropriate control node.

31. The communication system as claimed in claim 30,
wherein said at least one network node, said at least one control node and said at least one switching node are arranged in said first communication network, and
wherein communication between said at least one control node and said at least one switching node, and between said at least one network node and said at least one switching node, is in accordance with a Diameter protocol.

32. The communication system as claimed in claim 31, wherein said at least one network node is implemented by an application functionality or as part of said interface computer.

33. The communication system as claimed in claim 32, wherein said second communication network operates using a General Packet Radio Service standard and said interface computer is a Gateway General Packet Radio Service Support Node computer.

34. The communication system as claimed in claim 32, wherein said second communication network operates using a Wireless Local Area Network standard and said interface computer is a packet data gateway computer.

35. The communication system as claimed in claim 34, wherein said at least one control node is at least one edge node of said first communication network.

36. The communication system as claimed in claim 35, wherein said at least one switching node determines the appropriate control node by examining a request message for an identifier identifying the relevant communication terminal.

37. The communication system as claimed in claim 36, wherein the relevant communication terminal is identified by one of an internet protocol address, an International Mobile Subscriber Identity and a Mobile Station International ISDN Number of the relevant communication terminal.

38. The communication system as claimed in claim 37, wherein said at least one switching node forwards the request message directly to the appropriate control node responsible for the relevant communication terminal.

39. The communication system as claimed in claim 38, wherein said at least one switching node exclusively forwards an initial request message from a requesting network node to the appropriate control node responsible for the relevant communication terminal and thereupon transmits an answer message, generated by the appropriate control node, to the requesting network node.

40. The communication system as claimed in claim 38, wherein said at least one switching node switches all messages exchanged between said at least one network node and said at least one control node.

41. The communication system as claimed in claim 37, wherein said at least one switching node generates, as a response to a network request message generated by a requesting network node, an answer message in which the appropriate control node responsible for the relevant communication terminal is specified, and conveys the answer message to the requesting network node.

42. The communication system as claimed in claim 41, further comprising a relay agent, arranged between at least one of said at least one control node and said at least one switching node and between said at least one switching node and said at least one network node, forwarding at least one of request and answer messages therebetween.

43. The communication system as claimed in claim 42,
wherein each request message and each answer message specifies a source and a destination, and
wherein the requesting network node indicates a specific switching node as the destination in the network request message.

44. The communication system as claimed in claim 43, wherein the specific switching node, upon receiving the network request message, at least one of replaces the destination specified by the requesting network node in the network request message with the appropriate control node and replaces the destination specified by the appropriate control node in the answer message with the requesting network node.

45. The communication system as claimed in claim 44, wherein the specific switching node, upon receiving the network request message, leaves unchanged the source specified by the requesting network node in the network request message or, upon receiving the answer message, leaves unchanged the source specified by the appropriate control node in the answer message.

46. The communication system as claimed in claim 44, wherein the specific switching node, upon receiving the network request message, replaces the source specified by the requesting network node in the network request message or, upon receiving the answer message, replaces the source specified by the appropriate control node in the answer message.

47. The communication system as claimed in claim 43, wherein the specific switching node, upon receiving the network request message from the requesting network node, generates an answer message addressed to the requesting network node in which the appropriate control node is named as the destination for further communication.

48. The communication system as claimed in claim 42,
wherein said at least one network node generates a request routing message, and
wherein first messages exchanged between said at least one switching node and said at least one network node and second messages exchanged between said at least one switching node and said at least one control node have different application identifiers.

49. The communication system as claimed in claim 48, wherein said at least one switching node exchanges the identifiers when receiving any of the first and second messages.

50. The communication system as claimed in claim 42,
wherein said at least one network node generates a request routing message, and
wherein first messages exchanged between said at least one switching node and said at least one network node and second messages exchanged between said at least one network node and said at least one control node have different application identifiers.

51. The communication system as claimed in claim 50, wherein said at least one switching node, upon receiving the network request message from the requesting network node, generates an answer message addressed to the requesting network node in which the appropriate control node is named as the destination of the further communication.

52. The communication system as claimed in claim 51, wherein said at least one switching node has configuration information about allocation of the relevant communication terminal to the appropriate control node.

53. The communication system as claimed in claim 51, wherein said at least one switching node selects the appropriate control node for the relevant communication terminal.

54. The communication system as claimed in claim 53, wherein one of said at least one control node is selected as the appropriate control node by said at least one switching node when the identifier identifying the relevant communication terminal, extracted from a request message, is not yet known to said at least one switching node.

55. The communication system as claimed in claim 54,
wherein the at least one communication terminal includes a plurality of communication terminals, and
wherein said at least one switching node includes a plurality of switching nodes having communication links with one another to perform data exchange with regard to dynamically performed allocation of identifiers identifying the communication terminals.

56. The communication system as claimed in claim 55, wherein each of said at least one control node has allocation information about allocation of the communication terminals assigned thereto and transfer the allocation information in capability exchange messages to the switching nodes.

57. A switching node computer in a communication system having a first communication network, a second communication network with at least one communication terminal, an interface computer coupled to the first communication network that maps a data stream between the at least one communication terminal and the first communication network, at least one network node, and at least one control node in the first communication network controlling the data stream between the interface computer and the at least one communication terminal, comprising:
means for receiving, from one of the at least one network node, information used to control the data stream with respect to a relevant communication terminal; and
means for determining an appropriate control node allocated for the relevant communication terminal, so that the information can be conveyed to the appropriate control node.

58. A method for processing a message supplied to a switching node from a network node in a communication system having a first communication network, a second communication network with at least one communication terminal, an interface computer coupled to the first communication network that maps a data stream between the at least one communication terminal and the first communication network, and at least one control node in the first communication network controlling the data stream between the interface computer and the at least one communication terminal, comprising:
receiving, from the network node, information used to control the data stream with respect to a relevant communication terminal;
determining an appropriate control node allocated for the relevant communication terminal; and
conveying the information provided by the network node to the appropriate control node.
